(19) United States
(12) Patent Application Publication
(10) Pub. No.: US 2022/0077550 A1
(43) Pub. Date: Mar. 10, 2022

(54) Secondary Battery Module with Active Pressure Pad

(71) Applicant: SK Innovation Co., Ltd., Seoul (KR)

(72) Inventor: Jong Hyuk Lee, Daejeon (KR)

(21) Appl. No.: 17/468,861

(22) Filed: Sep. 8, 2021

(30) Foreign Application Priority Data
Sep. 9, 2020 (KR) 10-2020-0115337

(51) Int. Cl. H01M 50/618; H01M 10/63

(52) U.S. Cl. CPC H01M 50/618; H01M 2220/20; H01M 10/63

(57) ABSTRACT

Provided is a secondary battery module capable of constantly maintaining a surface pressure of a battery cell. The secondary battery module of the present invention includes a battery stack in which a plurality of battery cells are stacked; a case in which the battery stack is accommodated; a pressure pad disposed to be in contact with the battery cells constituting the battery stack and having a volume which is adjusted; and a pressure adjusting unit that adjusts the volume of the pressure pad in response to a measured pressure, thereby constantly maintaining the pressure applied to the battery cell.

### CROSS-REFERENCE TO RELATED APPLICATION

This application claims priority to Korean Patent Application No. 10-2020-0115337 filed Sep. 9, 2020, the disclosure of which is hereby incorporated by reference in its entirety.

### BACKGROUND OF THE INVENTION

### Field of the Invention

The following disclosure relates to a secondary battery module, and more particularly, to a secondary battery module capable of maintaining a constant surface pressure of a battery cell.

### Description of Related Art

Lithium secondary batteries are manufactured in the form of modules in which battery cells are stacked inside a case. Since the lithium secondary battery manufactured in the form of a module has a structure in which a plurality of pouches are stacked inside the case, the thicknesses of the stacked battery cells are combined when the battery cells are expanded to cause deformation of the case. On the other hand, when forming a free space in which the pouches may be expanded inside the case to prevent the deformation of the case, unbalanced charging may occur because an appropriate surface pressure may not be applied to the battery cells.

In order to solve such a problem, a technology has been developed that forms a free space in which the pouches may be expanded inside the case and applies a certain amount of surface pressure or more to the battery cells by attaching an elastic film to surfaces of the battery cells, but such a technology not only caused a problem in that a volume of the battery module was increased, but also had a problem in that it was impossible to apply a uniform surface pressure to the battery cells only with the elastic film.

Therefore, there is a need for a technology capable of preventing the battery module and the case from being deformed due to a change in the volume of the battery cells even if the battery cells are expanded during the charging/discharging process, and capable of always maintaining the constant surface pressure of the battery cell.

### RELATED ART DOCUMENT

### Patent Document

(Patent Document 1) Korean Patent Laid-Open Publication No. 10-2018-0068379 (published on Jun. 22, 2018 under the title “BATTERY CASE OF ELECTRIC VEHICLE”)

### SUMMARY OF THE INVENTION

An embodiment of the present invention is to provide a secondary battery module capable of uniformly charging a battery by maintaining a constant pressure applied to a battery cell without an increase in volume.

Further, an embodiment of the present invention is to provide a secondary battery module capable of preventing a battery module and a case from being deformed even when a battery cell is expanded.

Further, an embodiment of the present invention is to provide a battery pack including such a secondary battery module and an electric vehicle to which the same is applied.

In one general aspect, a secondary battery module includes: a battery stack 100 in which a plurality of battery cells 100A are stacked; a case 200 in which the battery stack 100 is accommodated; a pressure pad 300 disposed to have one surface or both surfaces to be in contact with the battery cells 100A constituting the battery stack 100 and having a volume which is adjusted; and a pressure adjusting unit 400 that adjusts the volume of the pressure pad 300 in response to a measured pressure.

The pressure pad 300 may have an accommodating space in which a fluid is accommodated, and the pressure adjusting unit 400 may adjust an amount of fluid located in the accommodating space.

The secondary battery module may further include a pressure measuring unit 500 that measures the pressure of the pressure pad 300 and provides information on the measured pressure to the pressure adjusting unit 400.

The pressure measuring unit 500 may include a hydraulic pressure measuring sensor 510 for measuring the pressure of the fluid located in the accommodating space.

The pressure measuring unit 500 may include a surface pressure measuring sensor 520 for measuring a surface pressure of the battery cell 100A.

The secondary battery module may further include a temperature adjusting unit 600 for adjusting a temperature of the fluid moving to the pressure pad 300.

The secondary battery module may further include a temperature measuring unit 700 for measuring the temperature of the fluid located in the accommodating space of the pressure pad 300 and any one or more of the battery cells 100A, and provides the measured temperature to the temperature adjusting unit.

The pressure pad 300 may have the accommodating spaces divided into a plurality of spaces, and the plurality of divided accommodating spaces are respectively connected to the different pressure adjusting units 400.

In another general aspect, an active pressure adjusting device for a battery module includes: a pressure pad having one surface or both surfaces in contact with a battery cell and having a volume which is adjusted; a pressure measuring unit for measuring a pressure applied to the pressure pad; and a pressure adjusting unit for adjusting the volume of the pressure pad in response to information on the pressure measured by the pressure measuring unit.

In still another aspect, a battery pack includes a lithium secondary battery module to which the active pressure pad is applied.

In still another aspect, an electric vehicle includes the battery pack to which the active pressure pad is applied.

### BRIEF DESCRIPTION OF THE DRAWINGS

FIG. 1 is a conceptual diagram illustrating a secondary battery module according to a first embodiment of the present invention;

FIG. 2 is a conceptual diagram illustrating a secondary battery module according to a second embodiment of the present invention;

FIG. 3 is a conceptual diagram illustrating a secondary battery module according to a third embodiment of the present invention;

FIGS. 4A and 4B are perspective views of an active pressure pad according to the present invention;

FIGS. 5A and 5B are perspective views illustrating modified examples of the active pressure pad according to the present invention;

FIG. 6 is a conceptual diagram for explaining a change in thickness for each location of a battery stack that appears when battery cells are expanded; and

FIG. 7 is a cross-sectional view illustrating an inner accommodating space of the active pressure pad according to the present invention.

### DESCRIPTION OF THE INVENTION

Hereinafter, a secondary battery module according to the present invention will be described with reference to the accompanying drawings.

Various advantages and features of embodiments of the present invention and methods accomplishing them will be apparent with reference to the embodiments described below in detail with the accompanying drawings. However, the present invention is not limited to the embodiments disclosed below, but may be implemented in various different forms, the present embodiments are merely provided to make the disclosure of the present invention complete and to fully inform the scope of the invention to those skilled in the art and the invention is only defined by the scope of the claims. Throughout the specification, like reference numerals refer to like components.

In describing the embodiments of the present invention, if it is determined that a detailed description of a known function or configuration may unnecessarily obscure the gist of the present invention, the detailed description thereof will be omitted. In addition, terms to be described later are terms defined in consideration of functions in the exemplary embodiments of the present invention, which may vary according to intentions or customs of users or operators. Therefore, the terms should be defined on the basis of the contents throughout the present specification.

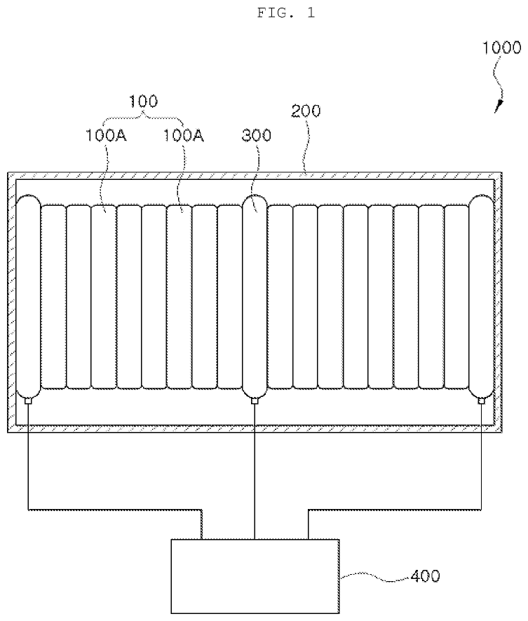

FIG. 1 is a conceptual diagram illustrating a secondary battery module 1000 according to a first embodiment of the present invention. Referring to FIG. 1, a secondary battery module 1000 according to a first embodiment of the present invention includes a battery stack 100 in which a plurality of battery cells 100A are stacked, a case 200 in which the battery stack 100 is accommodated, a pressure pad 300 disposed to have one surface or both side surfaces to be in contact with the battery cells 100A constituting the battery stack 100 and having a volume which is adjusted, and a pressure adjusting unit 400 that adjusts the volume of the pressure pad 300 in response to a measured pressure.

In more detail, during a charging/discharging process, the battery cells 100A are contracted or expanded, and in the case of stacking the battery cells 100A, when the stacked battery cells 100A are expanded, deformation may be accumulated and the case 200 may be deformed, or when the battery cells 100A are contracted, a pressure applied to the battery cells 100A may not be constant, so that the battery cells 100A may not be constantly charged. According to the present invention, it is possible to solve various problems caused by the expansion or contraction of the battery cells 100A by disposing the pressure pad 300 having a volume which is adjusted together with the battery stack 100 inside the battery case 200, and appropriately adjusting the volume of the pressure pad 300 in response to the expansion and contraction of the battery cells 100A using the pressure adjusting unit 400.

In this case, as an example of a method of adjusting the volume of the pressure pad 300 through the pressure adjusting unit 400, a method of forming an accommodating space in which a fluid is accommodated inside the pressure pad 300, and adjusting, by the pressure adjusting unit 400, an amount of fluid accommodated in the accommodating space may be used, and the pressure inside the pressure pad 300 may be adjusted using various methods.

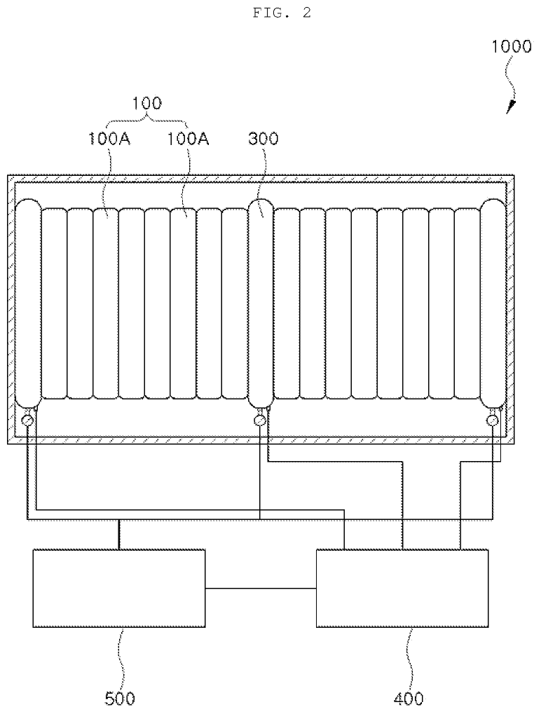

FIG. 2 is a conceptual diagram illustrating a secondary battery module according to a second embodiment of the present invention. Referring to FIG. 2, a secondary battery module 1000 according to a second embodiment of the present invention may further include a pressure measuring unit 500 measuring a pressure of the pressure pad 300 and providing information on the measured pressure to the pressure adjusting unit 400.

In more detail, as described in the first embodiment, the secondary battery module 1000 according to the present invention is to constantly maintain a pressure applied to the battery cells 100A constituting the battery stack 100 by adjusting the volume of the pressure pad 300. In order to more constantly maintain the pressure of the battery cells 100A, a plurality of pressure pads 300 may be provided between the battery cells 100A, a plurality of the pressure measuring units 500 may individually measure the pressure applied from the battery cells 100A located at different positions, and then provide information on the measured pressure for each position to the pressure adjusting unit 400, and the pressure adjusting unit 400 may adjust the volume of the plurality of pressure pads 300 to a value suitable for the measured pressure. Therefore, it is possible to minimize a pressure difference between the battery cells 100A, and it is possible to solve the charging imbalance problem between the battery cells 100A.

That is, according to the present invention, it is possible to minimize the pressure difference between the battery cells 100A, and it is possible to solve the charging imbalance problem between the battery cells 100A through an active pressure adjusting device for a battery module including the pressure pad having one surface or both surfaces in contact with the battery cells and having the volume which is adjusted; the pressure measuring unit measuring the pressure applied to the pressure pad; and the pressure adjusting unit adjusting the volume of the pressure pad in response to the information on the pressure measured by the pressure measuring unit.

On the other hand, the pressure pad of the present invention is preferably formed of a soft material, such as natural rubber or synthetic resin, so that the volume may be changed according to an internal pressure or an amount of fluid accommodated therein.

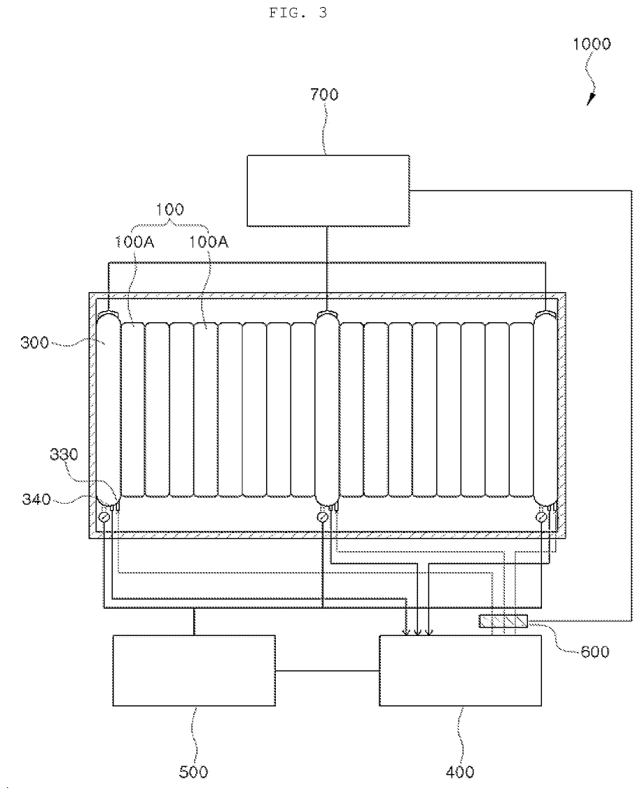

FIG. 3 is a conceptual diagram illustrating a secondary battery module according to a third embodiment of the present invention. Referring to FIG. 3, a secondary battery module 1000 according to a third embodiment of the present invention may further include a temperature adjusting unit 600 that adjusts a temperature of fluid moving to the pressure pad 300 in which a fluid inlet 330 through which the fluid flows into the pressure pad 300 and a fluid outlet 340 may be formed; and a temperature measuring unit 700 that measures the temperature of the fluid located on the accommodating space of the pressure pad 300 and provides the temperature measured by the temperature adjusting unit 600. In this case, the temperature adjusting unit 600 and the temperature measuring unit 700 may be connected to a cooling device (not illustrated), a heater (not illustrated), and a battery cell temperature control unit (not illustrated) for measuring and adjusting the temperature of the battery cells 100A to perform a function of controlling the temperature of the battery cells 100A together.

In more detail, since charging efficiency and safety of a battery are closely related to the temperature, it is important to maintain the temperature within a specified range in order to increase the charging efficiency and safety. Therefore, according to the present invention, the temperature measuring unit 700 measures the temperature of the battery cells 100A constituting the battery or the temperature of the pressure pad 300 that is disposed in close contact with the battery cells 100A to exchange heat with the battery cells 100A, and then provides real-time temperature information to the temperature adjusting unit 600 and the battery cell temperature control unit to control the cooling device or the heater of the battery module as well as to adjust the temperature of the fluid flowing into the pressure pad 300, thereby making it possible to more constantly maintain the temperature of the battery cells 100A.

When the pressure pad 300 and the pressure adjusting unit 400 are connected through one passage, it is difficult to circulate the fluid, so that temperature adjusting efficiency of the fluid is lowered, and in addition, when the fluid is sucked or injected in order to adjust the temperature, the volume of the pressure pad 300 may be changed without being constantly maintained. Therefore, the present invention recommends that individual fluid inlet 330 and fluid outlet 340 are formed on each of the pressure pads 300, and each of the fluid inlet 330 and the fluid outlet 340 are individually connected to the pressure adjusting unit 400, and the passage connected to the fluid inlet 330 has a path through the temperature adjusting unit 600 so that the temperature of the fluid may be adjusted by the temperature adjusting unit 600 before the fluid flows into the pressure pad 300.

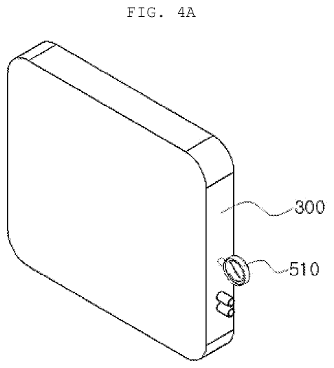

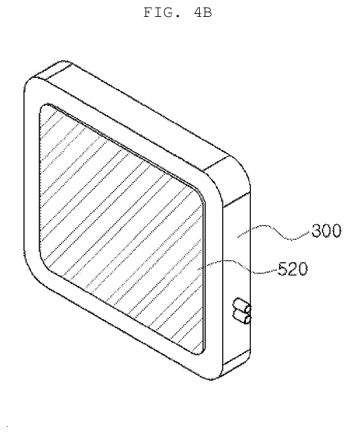

FIGS. 4A and 4B are perspective views illustrating embodiments in which a pressure measuring sensor communicating with the pressure measuring unit 500 is formed on the pressure pad 300. Referring to FIGS. 4A and 4B, according to the present invention, the pressure measuring unit 500 may include a hydraulic pressure measuring sensor 510 positioned at an edge of the pressure pad 300 and having one end communicating with the accommodating space formed inside the pressure pad 300 to measure the pressure of the fluid positioned in the accommodating space inside the pressure pad 300 as illustrated in FIG. 4A, and a surface pressure measuring sensor 520 positioned on the stacked surface of the battery cell 100A to measure a surface pressure of the battery cell 100A as illustrated in FIG. 4B.

On the other hand, although not illustrated in the drawing, the pressure measuring unit 500 may further include a pressure sensor provided inside the pressure pad 300 to measure a pressure of a surrounding fluid, and may include, without limitation, various devices capable of measuring the pressure.

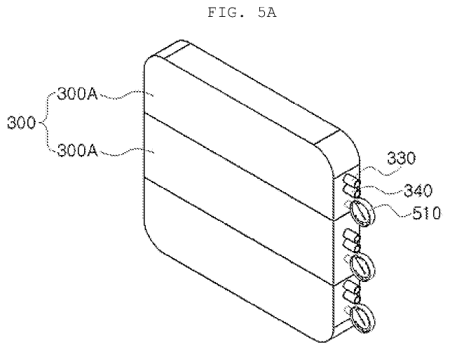

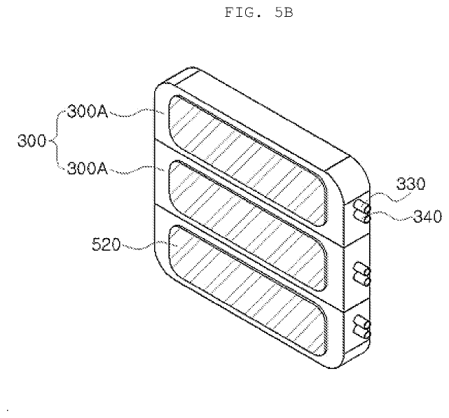

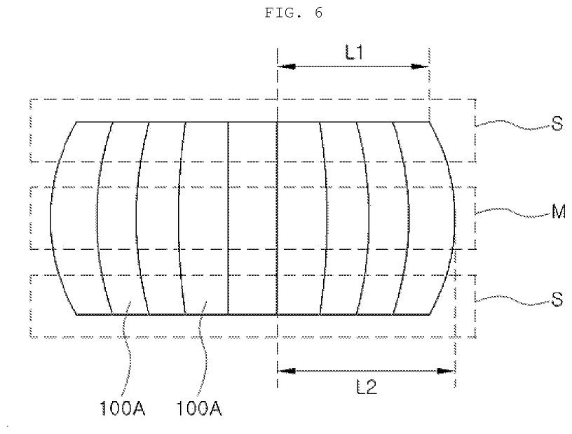

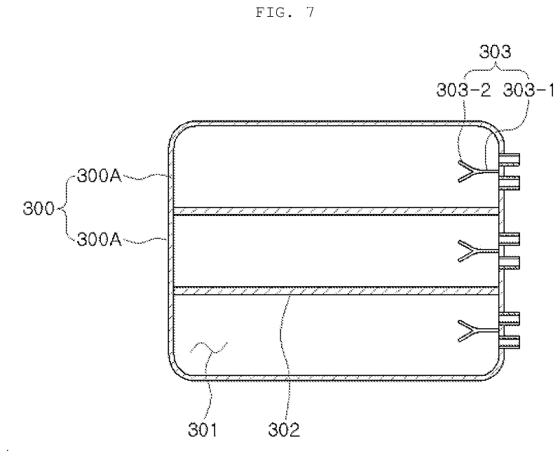

FIGS. 5A and 5B are perspective views illustrating that one pressure pad 300 is divided into a plurality of pressure pad unit bodies 300A, and the individual pressure measuring unit 500 is formed on each pressure pad unit body 300A, FIG. 6 is a conceptual diagram for explaining a change in thickness for each location of a battery stack that appears when the battery cells are expanded, and FIG. 7 is a cross-sectional view illustrating an inner accommodating space of the pressure pad 300 divided into the plurality of pressure pad unit bodies 300A.

Referring to FIGS. 5A and 5B, the pressure pad 300 may be divided into the plurality of pressure pad unit bodies 300A in which the inner accommodating spaces are isolated from each other. On each pressure pad unit body 300A, the fluid inlet 330, the fluid outlet 340, and the hydraulic pressure measuring sensor 510 may be separately formed as illustrated in FIG. 5A, or the fluid inlet 330, the fluid outlet 340, and the surface pressure measuring sensor 520 may be separately formed as illustrated in FIG. 5B.

In more detail, as illustrated in FIG. 6, when the battery cells 100A are charged after stacking a plurality of battery cells 100A, the central region M of the battery expands more than the edge region S of the battery, and the degree of expansion of each of the battery cells 100A is summed so that a length L2 of the expanded central region M becomes longer than a length of the expanded edge region L1. Therefore, although the pressure applied to the battery cell 100A is constantly maintained by applying a pressure to the battery cell 100A with the pressure pad 300 having the fluid located therein and deformable in response to an external force, a difference occurs between the pressures applied to the central region M and the edge region S of the expansion surface of the battery cell 100A. Therefore, according to the present invention, as illustrated in FIG. 7, by separating the accommodating space 301 formed inside the pressure pad 300 with a partition wall 302 to allow each pressure pad unit 300A to have an individual accommodating space, even when the battery cell 100A expands, the pressure may be more uniformly applied to the expansion surface of the battery cell 100A.

On the other hand, although it is illustrated on the drawing that the pressure pad 300 is divided into three pressure pad unit bodies 300A, this is an embodiment, and the pressure pad unit bodies 300A may have, without limitation, various structures, such as a structure in which one pressure pad unit body 300A is positioned in the center and one or more other pressure pad unit bodies 300A surround the pressure pad unit body 300A positioned in the center.

In addition, referring to FIG. 7, the pressure pad 300 may further include a branch unit 303 for isolating the fluid inlet 330 and the fluid discharged to the fluid outlet 340 from each other therein.

In more detail, as described above, according to the present invention, the temperature of the battery cell 100A is maintained at a specified level to increase charging efficiency and stability. In this case, when the inflow of the fluid through the inlet 330 and the discharge of the fluid through the fluid outlet 340 occur at the same time, cooling air introduced through the fluid inlet 330 is discharged to the fluid outlet 340 in order to stabilize the temperature of the battery cell 100A, which may cause a problem in that temperature adjusting efficiency is lowered. Therefore, according to the present invention, such a problem is solved by forming the branch unit 303 between the fluid inlet 330 and the fluid outlet 340.

In this case, the branch unit 303 may have various shapes, and may have a shape in which a pair of bent portions 303-2 spreading from the center to the edge is formed at the end of a branching plate 303-1 to adjust a flow direction of the fluid as illustrated in FIG. 7.

Since the secondary battery module according to the present invention may evenly apply the constant pressure to the battery cells, it is possible to solve the charging imbalance problem that occurs when the pressure is not constant.

In addition, it is possible to solve the problem that the life of the battery is reduced due to lithium ions deposited on the surface of the negative electrode due to pressure imbalance.

In addition, it is possible to solve the problem in which deformation occurs due to pressure applied to the case of the battery when the battery cells are expanded.

Further, since the pressure pad is divided into a plurality of zones and the pressure may be individually adjusted in each of the divided zones, it is possible to maintain a more constant surface pressure of the battery cells.

The present invention is not limited to the above-described embodiments, and may be variously applied. In addition, the present invention may be variously modified by those skilled in the art to which the present invention pertains without departing from the spirit of the present invention claimed in the claims.

### DETAILED DESCRIPTION OF MAIN ELEMENTS

100: battery laminate 100A: battery cell

200: case

300: pressure pad

400: pressure adjusting unit

500: pressure measuring unit 510: surface pressure measuring sensor

520: hydraulic pressure measuring sensor

600: temperature adjusting unit

700: temperature measuring unit

What is claimed is:

1. A secondary battery module comprising:
a battery stack in which a plurality of battery cells are stacked;
a case in which the battery stack is accommodated;
a pressure pad having one surface or both surfaces configured to be in contact with a battery cell among the plurality of battery cells and having a volume configured to be adjusted; and
a pressure adjusting unit configured to adjust the volume according to a measured pressure information.

2. The secondary battery module of claim 1, wherein the pressure pad comprises an accommodating space configured to accommodate a fluid, and the pressure adjusting unit adjusts an amount of the fluid.

3. The secondary battery module of claim 1, further comprising a pressure measuring unit configured to measure a pressure applied to the pressure pad and provide information on the measured pressure to the pressure adjusting unit.

4. The secondary battery module of claim 3, wherein the pressure measuring unit comprises a hydraulic pressure measuring sensor for measuring the pressure of the fluid located in the accommodating space.

5. The secondary battery module of claim 3, wherein the pressure measuring unit comprises a surface pressure measuring sensor for measuring a surface pressure of the battery cell.

6. The secondary battery module of claim 3, further comprising a temperature adjusting unit configured to adjust a temperature of the fluid.

7. The secondary battery module of claim 6, further comprising a temperature measuring unit configured to measure a temperature of at least one of the fluid and the battery cell and provide the measured temperature to the temperature adjusting unit.

8. The secondary battery module of claim 2, wherein the pressure pad comprises a plurality of accommodating spaces, and the plurality of accommodating spaces are coupled to a respectively different pressure adjusting unit.

9. The secondary battery module of claim 2, wherein the pressure pad is formed of a flexible material whose volume changes according to an amount of the fluid.

10. An active pressure adjusting device for a battery module comprising:
a pressure pad having one surface or both surfaces in contact with a battery cell and having a volume which is adjusted;
a pressure measuring unit for measuring a pressure applied to the pressure pad; and
a pressure adjusting unit for adjusting the volume of the pressure pad in response to information on the pressure measured by the pressure measuring unit.

11. The active pressure adjusting device for a battery module of claim 10, wherein the pressure measuring unit comprises a hydraulic pressure measuring sensor for measuring a pressure of fluid located on an accommodating space or a surface pressure measuring sensor for measuring a surface pressure of a battery cell.

12. The active pressure adjusting device for a battery module of claim 11, further comprising:
a temperature adjusting unit for adjusting a temperature of the fluid moving to the pressure pad; and
a temperature measuring unit for measuring the temperature of the fluid located in the accommodating space of the pressure pad and any one or more of the battery cells, and provides the measured temperature to the temperature adjusting unit.

13. The active pressure adjusting device for a battery module of claim 10, wherein the pressure pad has the accommodating spaces divided into a plurality of spaces, and the plurality of divided accommodating spaces are respectively connected to the different pressure adjusting units.

14. A battery pack comprising the secondary battery module of claim 1.

15. An electric vehicle comprising the battery pack of claim 14.
